(19) United States
(12) Patent Application Publication
(10) Pub. No.: US 2023/0368471 A1
(43) Pub. Date: Nov. 16, 2023

(54) METHOD AND SYSTEM FOR CONVERTING 2-D VIDEO INTO A 3-D RENDERING WITH ENHANCED FUNCTIONALITY

(71) Applicant: Joseph Isaac Gratz, Valparaiso, IN (US)

(72) Inventor: Joseph Isaac Gratz, Valparaiso, IN (US)

(21) Appl. No.: 18/196,647

(22) Filed: May 12, 2023

Related U.S. Application Data
(60) Provisional application No. 63/341,461, filed on May 13, 2022.

(51) Int. Cl. G06T 19/00; G06T 7/70; G06T 17/00; H04N 21/2343

(52) U.S. Cl. CPC G06T 19/00; G06T 7/70; G06T 17/00; H04N 21/23439; G06T 2210/32; G06T 2207/10016; G06T 2200/24; G06T 2207/30221

(57) ABSTRACT

Methods and systems are disclosed for the conversion of a two-dimensional video media into a rendered three-dimensional video media, said conversion commonly being facilitated by at least one database having frames of pre-rendered three-dimensional recreations containing at least one rendered model in at least one location and in at least one pose within a rendered area, and having a means for selecting the pre-rendered three-dimensional frame from the database that most closely resembles the two-dimensional video media. Further embodiments include interactable elements in the rendered three-dimensional video media, said interactable elements displaying information when the interactable element is manipulated by a user.

### CROSS REFERENCE TO RELATED APPLICATIONS

This application claims the benefit of U.S. Patent Application No. 63/341,461, filed May 13, 2022, and titled “METHOD, SYSTEM, AND APPARATUS FOR CONVERTING 2-D VIDEO INTO A 3-D RENDERING WITH ENHANCED FUNCTIONALITY,” the contents of which are incorporated in their entirety.

### FIELD OF INVENTION

The present invention generally relates to the conversion of 2-D (two-dimensional) video media into a rendered 3-D (three-dimensional) video media. More particularly, embodiments of the present invention relate to the conversion of 2-D video media into a feature-enhanced piece of rendered 3-D video media including adaptive player posing, frame generation, and the presentation of supplementary data.

### BACKGROUND OF THE INVENTION

Video media, including broadcast video, has been a staple of information and entertainment in much of the world since the mid-1900s. Particularly in more developed countries, television sets and other various forms of viewing screens have firmly taken hold in the workplace, home, waiting rooms, businesses, and (most importantly today) in the palm of many smartphone owners' hands. While the screens, playback methods, and broadcasting/streaming techniques and technologies have been innovated over and over, some forms of video media have not seen tremendous innovation (beyond increased resolution, frames per second, and bitrate).

Indeed, while many screens used today are either coupled to a computer system or part of a smartphone, many forms of video media have generally not taken advantage of these additional resources beyond recording a broadcast, pausing a video stream, adjusting display options, and scrubbing forward and backwards within the video media. As an example, one reason for the slower rate of growth in these technologies is because converting a 2-D broadcasted video stream into a more adaptive, information dense, and interactable piece of media requires more processing power than many consumer devices can (or at least could) provide within a desirable timeframe (sometimes instant to seconds). Further, some users of current or recent past technologies may experience delays, buffering, or other inconveniences if the video media's volume of streaming data is too high. This has left at least some of those users with, conceptually and substantially, the same 2-D broadcast video streams for over 50 years.

### SUMMARY OF THE INVENTION

The following presents a simplified summary of the present invention to provide a basic understanding of the invention's concepts. This summary is not an extensive overview, and it is not intended to identify critical elements or to limit the scope of this discloser. The sole purpose of this summary is to present some general concepts in a simplified form as a prelude to the detailed description of the invention.

The subject matter disclosed and claimed herein, in some embodiments of the present invention, relates a computer-implemented method for converting two-dimensional video media into a rendered three-dimensional video media, comprising the steps of: identifying at least one object from at least one frame of two-dimensional video media; assigning at least one node to the at least one object; determining location data for the at least one object based on the at least one frame; determining pose data for the at least one object within the at least one frame; rendering at least one rendered model to be placed and posed in a rendered area of a rendered three-dimensional recreation of the two-dimensional video media, wherein the rendered model is used to replace its counterpart at least one object from the two-dimensional video media, and the rendered model having at least one node that correlates to the at least one node of the at least one object; generating a plurality of poses for the at least one rendered model in a plurality of locations in the rendered area and said plurality of poses being generated by manipulating the rendered model's at least one node; storing the location and pose data of the at least one node of the at least one rendered model within at least one pre-rendered frame of the rendered area in at least one database; comparing the location and pose data of the at least one node of the at least one object with the corresponding at least one node of the at least one rendered model within the database; selecting the pre-rendered frame within the database containing the at least one rendered model at a corresponding location and pose that most closely aligns with the at least one node of the at least one object from the two-dimensional video media; displaying to a user the pre-rendered frame most closely corresponding to the two-dimensional video stream; generating at least one interactable element that corresponds to a at least one node of the at least one rendered model; receiving manipulation by a user at the at least one interactable element; and displaying information related to the at least one rendered model.

The subject matter disclosed and claimed herein, in some embodiments of the present invention, relates to a computer system for converting a two-dimensional video media into a rendered three-dimensional video media comprising at least one computer processor; at least one frame controller; at least one translation controller; at least one reference controller; and a program memory storing executable instructions that when executed by at least one computer processor causes the computer system to: render at least one rendered model to be used in a rendered area of at least one frame of a rendered three-dimensional video media, said at least one rendered model being used to replace a counterpart at least one object of the rendered model from a two-dimensional video media, and said rendered model having at least one node; store a plurality of poses for the at least one rendered model in a plurality of locations in the rendered area in a pose reference database; store at least one pre-rendered frame of the at least one rendered model within the rendered area at pluralities of locations and poses in a pre-rendered frames database; assign location and pose data for the at least one node of the at least one rendered model within the at least one pre-rendered frame within the pre-rendered frames database; capture and assign location and pose data from at least one frame of two-dimensional video media for at least one object that is the counterpart of the at least one rendered model; select the pre-rendered frame from the pre-rendered frames database having the most desirable accuracy coefficient between the at least one object of the two-dimensional video media and the at least one rendered model of the pre-rendered frame; generate at least one interactable element that corresponds to at least one node of the at least one rendered model; display the pre-rendered frame to a user; receive manipulation by the user at the interactable element; and display information via the interactable element that is related to the manipulated node of the rendered model.

To accomplishment of the foregoing and related ends, certain illustrative aspects of the disclosed innovation are described herein in connection with the following description and the annexed drawings. These aspects are indicative of only a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The embodiments of the present invention disclosed herein are illustrated by way of example, and not by way of limitation, in the figures of the accompanying drawings, in which like reference numerals may refer to similar elements.

FIG. 1 is a workflow of one embodiment of the method for creating a 3-D model and pose reference database.

FIG. 2 is a workflow of one embodiment of the method for translation of pose coordinates from a 2-D video media into frames comprising models and poses recreated in a rendered 3-D video media.

FIG. 3 is a workflow of one embodiment of the method for displaying information on rendered models in a rendered 3-D video media.

FIG. 4 provides an exemplary system of the present invention.

FIG. 5 depicts a rendered 3-D model of a single hockey player with a generated nodal skeleton.

FIGS. 6a-6e are of various stages of processing of one embodiment of the present invention.

### DETAILED DESCRIPTION OF THE PRESENT INVENTION

The innovation is now described with reference to the drawings, wherein reference numerals are used to refer to elements throughout. In the following description, for purposes of explanation, numerous specific details are set forth to provide a thorough understanding of the present invention. It may be evident that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

The transformation of 2-D video media into a more adaptable and interactive medium poses great benefit to businesses, analysts, hobbyists, viewers, fans, and other users. However, current hurdles to such innovation include processing power, required processing time, the amount of data sent, and the accuracy of the rendered 3-D video media. The information gained from a rendered 3-D interactable video media would allow users to analyze the recorded and/or broadcasted (whether broadcast from a traditional cable, satellite, etc. source or streamed from a cellular phone, personal computer, or similar device) information from a variety of perspectives and in relatively real-time. In addition, supplementary data could be added to the rendered 3-D interactable video for the sake of adding information, context, trivia, and other desirable tidbits that enhance the user's consumption, analysis, and/or enjoyment of the video media. Further, there is a need for a technology, such as the present invention, which is adept at conversion of 2-D to 3-D video media from a camera perspective that is capable of moving (this means cameras that rotate or move along a plane, not a change in perspective via a change in video source feed).

In some embodiments, at least one virtual model is rendered by a system to be used to replace a counterpart object detected in a 2-D video media. The objects and/or models (both real and virtual) include, by way of example and not limitation, persons (such as athletes participating in a sporting event), sporting equipment (such as a hockey puck, goal, stick, baseball, bat, football, soccer ball, etc.), objects (including vehicles, signs, clothing, dinnerware, cellular phone, chairs, or any other moveable items), and intangibles (for example, a screen filter indicating the direction or intensity of rain or wind). The rendering of the virtual models is accomplished by the system using at least one rendering application designed to extract visual data from at least one frame of the 2-D video media, analyze the real-world (2-D) object(s), process the data, and generate a 3-D representative model(s) of the 2-D object(s). In some embodiments, a receiver may receive the 2-D video media and a frame controller will be used to select the desired frame for model conversion from 2-D to 3-D. This 2-D video media may be recorded in a recording database.

Analysis of any real-world object includes using at least one multiple object tracking software or algorithm (hereafter, for the sake of brevity, “MOT program”) to identify the objects, assign values to pixels corresponding to each individual object, and, more importantly, reidentify (or recognize) objects that may leave and re-enter the frame in the 2-D video media. Many MOT programs are able to merely identify and track multiple objects in 2-D video; however, more complex (and desirable programs for the present invention) include quick re-identification of the object after re-entering the frame of 2-D video media. Identification, tracking, and re-identification may be performed by pixel identification, cluster of pixel identification, edge detection, recognition of motion through multiple frames, generation of bound boxes, and other common techniques (the most suitable of which for the present invention focuses on speed and processing efficiency over pure accuracy). Further, many of the desirable embodiments of this component of the present invention typically involve trained machine learning algorithms which are proven to be adept at swift re-identification.

In embodiments of the present invention focused on the recreation of sporting events such as football, hockey, basketball, etc. the MOT program should be able to identify players/participants, equipment (such as a hockey puck or basketball), and goals (whether this means one of two goals in a hockey rink, one of two hoops on a basketball court including tracking whether the basketball goes through said hoops, or the endzone and field goal posts on a football field). In further embodiments, the MOT program may assign each object or even a node on the object a location. In some embodiments, this may be a representative X-Y coordinate for the object or pixel denoted to be representative of the object. The X-Y axis may be based on the height and width of the frame, a tracked center of the playing area, or some other location, pixel, reference point, or object that appears in at least one of the frames of the 2-D video media.

The next step after objects have been identified and are re-identifiable and trackable, in some embodiments, includes feeding the generated data from the 2-D video media and/or the MOT program through a pose estimation program which assigns nodes to the objects/models (for example, at the player's joints like ankles, knees, elbows, shoulders, etc.). Further, the pose estimation program may assign location values for each generated node. The accuracy of the pose estimation program is pivotal for the accurate processing of the 2-D video media into a rendered 3-D recreation. That is to say, the pose estimation program is similar to a foundation of a house and any errors or imperfections present in the pose estimation program's output may cascade into more noticeable differences between the 2-D and 3-D video medias. Some currently available (and even open source) 2-D pose estimation software, algorithms, and programs have been using artificial intelligence and/or machine learning trained components that will only grow more accurate over time.

In some embodiments, 3-D models are generated or created, ideally, including a linked node framework (sometimes referred to as a “skeleton” or “rig”) that includes the same number and labeled nodes as articulated by the pose estimation program. These 3-D models may be generated by a program or created by an individual using 3-D modeling software. With any 3-D model generated or created for the present invention, there are several balancing factors that have varied benefits. For example, lower polygon count (or lower fidelity models) typically results in faster processing speeds at the cost of details and/or aesthetics. On the other hand, some end users may prefer higher graphical fidelity over video processing speed (like if the end user is generating the recreation of a game instead of focusing on watching the 3-D recreation as a live event). Multiple 3-D models that use the same skeleton may have proportions changed to better reflect a 3-D representation of the actual player/participant's height, weight, build, etc. These 3-D models may include variable “skins” which display a player's home jersey, away jersey, other attire, or other aesthetic features.

These 3-D models may be posed in a plurality of positions (or “poses”) to facilitate use of the 3-D models within the present invention. The same or a different application than the 3-D model generation and/or creation application may be used to create posed 3-D models. These poses may be created manually by an individual or generated by an application. Further, poses may include telescoping extensions or retractions between nodes. The poses may be generated or created by software or a human manipulating variations in the rotations and/or telescoped distances between the at least one node on the at least one rendered model. The rotations about the axis may be restricted to a set of parameters to prevent the generation program from wasting time and resources creating poses that are very unlikely or impossible. One example of an unlikely or impossible pose is one of a human where the head is spun 180 degrees about its original orientation. Likewise, parameters may be set that prevents the extension or retraction of the distance between two nodes beyond a predetermined amount. The 3-D models should include at least one node that is used as an axis and/or as a point to determine a length between that node and at least one other node. In most cases, at least one node is interior to the model and is somewhat of a pivot point for poses. In some embodiments, the generation and/or creation of posed 3-D models requires at least one 3-D rendering engine and a database management system. A variety of programming languages may be employed to accomplish these tasks such as C # or Python.

Whether generated by the application or created by the individual, the present invention benefits by having a large number of available poses for the 3-D model(s). Further, the present invention is contemplated to work with both, systems including one base skeleton which may or may not be stretched to match the size and/or proportions of the 3-D models and that allows any 3-D model to conform to a generated pose, and also systems including a plurality of 3-D models of different proportions and sizes each having unique, dedicated poses. Regardless of the system, typically, the greater the number of available poses the any 3-D model, the more accurately that the 3-D model reflects the actual 2-D object present in the 2-D video media. Preferred embodiments focus on creating poses that are likely to occur, such as poses for a 3-D model that is likely to occur within the course of a sporting event. Again, the greater the number of poses, the more fluid and accurate the movement and position of the 3-D model correlates with its real counterpart form the 2-D video media. It is not unrealistic for the application to generate or individual(s) to create more than ten thousand different configurations of 3-D model(s) to store within a database because pre-rendered 3-D model(s) generally means faster processing times and less processing power. Likewise, parameters or rules may be set as to not overly generate or create poses or configurations of 3-D models on a playing area that are too similar or even redundant. For example, the playing area may be dividing up into units with positions like on a grid, in this case every point on the grid is separated by every other point by at least one meter (creating a grid the size and shape of the playing area with one meter between every point on the X-axis and one meter between every point on the Y-axis).

In some embodiments, depending on the distance between each point of the grid defining the playing area where 3-D models are posed to represent the players in the 2-D video media, the 3-D completed renderings of the 3-D models on the grid may serve as keyframes and the system may process intermediate frames that translate the change in location of the 3-D models and the change of pose of each respective 3-D model. These intermediate frames may generated by a predictive algorithm. This recreation and rendering of the movement of the players and their poses on the playing area takes more processing time and power than merely using pre-rendered images; however, it creates fluidity in movement and boosts the overall accuracy of the recreated rendering. Importantly, the grid as described above is for general model placement and the X,Y coordinates that comprise it are not necessarily the exact X,Y coordinates that may be recorded for each node on the objects or models who may be assigned decimal values instead of whole numbers in order to most accurately record the nodes' locations.

In some embodiments, a translation controller may consist of at least one physical and/or software components and may be used for (and include at least one software program directed to) object/model detection, identification, location mapping, pose detection, and to facilitate the identification, selection, capture, and 3-D conversion of desired objects from the 2-D video media. The translation controller may store its data of the objects/models and their poses in a pose reference database. Those experienced in the art will appreciate that having more frames of the 2-D video media, especially frames from a variety of angles and distances, allows the rendering program(s)/controller(s)/module(s) to generate more accurate 3-D models and/or more accurate poses for those 3-D models within a playing area/field. It is valuable to record the models and poses in a pose reference database because, generally, a pre-rendered pose of the rendered 3-D model may be retrieved and replace a corresponding 2-D object more quickly than generating a similar pose in real-time for the 3-D model based on pose data from the corresponding object in the 2-D video media.

In some embodiments, a reference controller is used to identify real-life objects, their locations, and their poses from the 2-D video media and place 3-D models at corresponding locations about a rendered 3-D recreation of a rendered area or playing area/field (such as a room, arena, field, setting, etc.) in pre-rendered poses. This placement may desirably correspond to the location of the real-world object that was extrapolated from 2-D video media. In some embodiments, artificial intelligence algorithms or other software programs may be used to identify the locations of objects in the 2-D video media. In an alternative embodiment, the prediction algorithm may place the 3-D model or models on the playing area as well as generate or select an estimated pose for each 3-D model. The rendered area may itself be a 3-D model.

The prediction algorithm may generate a plurality of poses for the 3-D models and place them at a plurality of positions about the rendered area. A syncing and/or accuracy modules of the prediction algorithm may select the pre-rendered 3-D video media which is most like the 2-D video media. This may be accomplished on a frame-by-frame basis or by the syncing and/or accuracy modules comparing the pre-rendered 3-D video media with the 2-D video media at keyframe intervals. The keyframe intervals may be adjusted based on how accurately the user of the system wishes for the location and poses of the rendered 3-D video media to reflect their corresponding location and poses in the 2-D video media. Those experienced in the art will appreciate how the use of keyframe intervals may reduce the processing power and/or time required for the syncing and/or accuracy modules to perform their tasks without delaying the stream of rendered 3-D video media. If keyframe intervals are used, the rendering application may use interframes to show the predicted movement of the 3-D models between keyframes. Interframes reduce the technical load and processing time of the conversion of the 2-D video media to a rendered 3-D video media.

In even further alternative embodiments, renderings of the 3-D models about a variety of locations may be pre-recorded to create or generate pre-rendered frames of at least one 3-D model in at least one pose in at least one location on the rendered area within the frame.

In some embodiments, whether generated by the reference controller, a predictive algorithm, other techniques, or some combination of the foregoing, the generated 3-D frames of model and pose data at a plurality of locations on the rendered area may be stored in a pre-rendered frames database. This pre-rendered frames database may expedite the recreation of the 2-D video media into rendered 3-D video media in some embodiments of the present invention. Further, the predictive algorithm may be used to generate model and node locations that are outside of the frame in the 2-D video media. These predicted positions may be helpful as the user moves, rotates, or otherwise changes the camera position within the rendered 3-D recreation of the 2-D video media.

In order to select the rendered 3-D recreation (whether from the pre-rendered frames database or another repository of recreations) most aligned with the 2-D video media, a corresponding model selection program may be executed which assigns an accuracy coefficient based on the location of at least one of the corresponding nodes on any or every object (2-D and real-world) and model (3-D), for example the right ankle of every player. In one embodiment, the corresponding model selection program may compare the assigned location of the nodes of the objects or models based on the X,Y (and Z for 3-D) coordinates (for clarity, this means the actual decimal coordinates and not necessarily the object or model coordinates on the X,Y (and potentially Z) grid of the playing area). This process is aided by utilizing a database with efficient database management software/frameworks for the quick retrieval of pre-rendered 3-D model/node location data. In this comparison, the corresponding model selection program may combine the differences in the X coordinate of each node and the Y coordinate of each node, assign a value, and select the rendered 3-D recreation from the frames database having the lowest value across all desired nodes. By “the differences in the X coordinate of each node and the Y coordinate of each node” the corresponding model selection program may take the difference between both X coordinates and both Y coordinates and combine the result (for example: node 1 has an X value of 4.5 and a Y value of 0.2, node 2 has an X value of 5.0 and a Y value of −1, the aggregate accuracy coefficient would be ((5.0-4.5)+(0.2−(−1))) or 1.7). The lower the value of the accuracy coefficient, the less the difference between the nodes of the objects and models. Further, certain nodes may receive a multiplier to their accuracy coefficient to make their values more focal to selecting the most viewing optimized rendered 3-D recreation. For example, nodes including and near the hockey puck or basketball may receive the multiplier for the accuracy coefficient because they are closer to the current focus of the game. This multiplier may be greater or less than one. The greater the multiplier, the more important those corresponding nodes accuracy are for selecting the closest rendered 3-D recreation of the 2-D video media. More advanced algorithms are capable of estimating the Z-axis coordinate for objects and models in 2-D video media. These more advanced versions of the present invention enjoy greater precision/accuracy of 3-D model placement in rendered frames; however, this may come at the cost of increased processing time and required resources due to the extra step. One example of Z-axis estimation from 2-D video media includes using extrapolated data from the frame(s) as well as reference data such as the height of a hockey goal or basketball net, the width of bounds painted on the field, the height of any barrier present on or near the playing area, etc.

In alternative embodiments, the Z-axis may be unique to each object/model at a “root” node/joint. This allows the nodes that are not the root node to have a measurable X, Y, —and—Z-axis difference that is more easily discernable and can be used to determine lowest aggregate accuracy coefficients more precisely for model and pose selection in the rendered 3-D recreations.

In some embodiments, the present invention includes means for a viewing angle to be positioned anywhere in the rendered 3-D area. However, technical necessity may prefer to have a single viewing angle be used at a time for the sake of processing, memory, and time resources, this depends on the embodiment of the present invention with desired benefits that a provider or user chooses. The viewing angle may be changed through the recording of the rendered 3-D video media to the database. In some embodiments, the changing of the viewing angle may mimic the viewing angle changes of the 2-D video media used as the source for the 3-D rendering. In alternate embodiments, the viewing angle may be changed during still frames or playback in accordance with the user's desire or by an algorithm designed to capture interesting portions of the captured 2-D video media. In some embodiments, interesting portions of the captured 2-D video media may be determined by the user, an algorithm designed to detect and capture specified events in a 2-D video media, an algorithm designed to detect the parameters such as the highest degree of change in the object's location and/or poses, or some combination of the foregoing.

In some embodiments, in order to create an accurate recreation of the 2-D video media in the rendered 3-D video media, the present invention may compare the pre-rendered 3-D frames of video media to the actual 2-D video media; then, a video assembly algorithm may recreate the 2-D video media in an accurate rendered 3-D video media which gives users the ability to, among many other possibilities, pause the video stream, rotate the camera, analyze the location and/or poses of the 3-D models, review secondary data (such as player or game statistics relevant to the sporting event played in the 2-D video media), and/or interact with elements inserted into the 3-D video media. When creating the rendered 3-D video media, the video assembly algorithm compares the location of all 3-D models and their positions in the area with their object/model counterparts in the 2-D video media. The pre-rendered 3-D frame with the closest match (or lowest (best) accuracy coefficient) of location and position of the 2-D objects and 3-D models are used to represent the corresponding frame of the 2-D video media. In the event there are multiple objects and models, the frame with the collective most accurate locations and/or poses may be used. Alternatively, the user may select to use pre-rendered frames that reflect the most accurate correlation to a set number of or selected objects/models in the 2-D video media. Embodiments of the present invention focused on speed may boast that they display the rendered 3-D recreation of 2-D video media in relatively real-time (which means the process is completed fairly quickly such as in a matter of seconds).

There may be some disparity between the 2-D video media and the 3-D video media; however, the large database(s) involved with the operation of present invention tend to make any such disparity an immaterial change to the overall conversion of video media. For example, a person in the 2-D video media may have their hand in one orientation on the 2-D video and in another orientation on the rendered 3-D video media. Especially if that hand is not interacting, recently interacted, or soon to be interacting with another model, such a change in hand pose does not affect the location or overall pose of the model or usefulness of the present invention. Therefore, using pre-rendered frames with the person's hand in a nonmatching pose is not a significant impact on the user. Further, this means that assigning multipliers to accuracy coefficients for nodes that are most important to the actions performed during the sporting event aids the present invention in generating/creating a 3-D video media that is most useful to the user

Those skilled in the art as well as those analyzing the events on the 2-D video media in the rendered 3-D recreation will appreciate the features of the present invention. One such feature could be a sport analyst evaluating the locations and poses of a set of teams on a field. Such analytics may prove valuable when forming strategies against or determining weakness in a formation of a sports team. Another possible use would be using 2-D traffic footage and/or footage from surrounding cameras to recreate the rendered 3-D video media of a traffic accident. This could aid the user in determining fault and/or damage during the recorded event. Further, if such an event was not captured in a continuous stream, the recreated of the event using the present invention may be useful due to the accuracy of known machine learning techniques that are skilled in locomotion prediction and rendering.

In some embodiments of the present invention, there may be variations between location and pose data of the object in the 2-D video media and its model counterpart in the rendered 3-D video media. The frame controller, translation controller, reference controller, predictive algorithms, rendering algorithms, volume of pre-rendered video media in the database, and additional units, models, databases, etc. within the system often allows for faithful recreations of the 2-D video media in 3-D that present all important information to the user. For example, the user may desire to have accurate location data of the players in a hockey match, but the user may not care about the exact poses of players who are not the goalie and not near the hockey puck.

As an alternative example, the user may desire to select certain real-world objects recorded on a cellular phone or from a CCTV camera during an automobile accident (such as the two vehicles involved in the accident). Due to the nature of understanding who is at fault and many states choosing not to use “phantom driver” laws, the user may select to only render 3-D models for the two vehicles involved.

In some embodiments, selected nodes or points in the rendered area may have an interactable element that, when manipulated by the user, displays information. The interactable element may appear as an indicator, such as a small circle on the 3-D model and is interactable through a graphical user interface such as with a touchscreen tap or mouse cursor click. Further, some embodiments of the present invention may present an interactable element that is highlighted, called attention to, or presented by viewer attention grabbing mechanisms such as flashing regions of the screen; glowing or otherwise highlighting a relevant piece of the models, nodes, or playing area; or the appearance of an icon, text, or other attention grabbing means. In further embodiments, this information may be stored in a statistics and information database.

In alternative embodiments, the displayed information may appear and be linked to or hover near the relevant or selected node, requiring no user manipulation for the appearance of the displayed information. This method may be viewed, colloquially, as a “pop-up” information display and, in further alternative embodiments, the user may click on the pop-up or a removal indicator (such as an “x” within a red circle) to cause the pop-up to disappear. In some embodiments, the pop-up may direct a web browser on the user's device to a specified web page if the user clicks on the pop-up. “Clicking” the pop-up may refer to using a mouse, keyboard, touchscreen, or other input method to interact with the pop-up. Further, the user may be able to remove the pop-up on a touchscreen device by touching the pop-up and, without breaking contact with the screen, swiping the pop-up to the edge or off the screen. Lastly, the pop-up may include, by default, a display timer that counts down until 0 when the pop-up disappears. Once the timer expires, the pop-up may disappear on the next frame, “fade out” via an increased transparency gradient algorithm or be removed by some other aesthetically pleasing means.

The displayed information may be based on the selected node. For example, selecting a node that overlaps a hockey skater's footwear may display information related to the hockey skater's speed and/or direction. Further, selecting a node covering the hockey player's hand may show statistics for that hockey player's shot accuracy and number of goals scored. Even further, selecting a node on the body or head of the hockey skater may display biometric information such as the hockey skater's height, weight, age, eye color, etc. This information may only be displayable while the rendered 3-D video stream is paused, or it may be displayed during the playing of said video stream. If the information is displayed while the video stream is playing, the displayed information may follow the location of the hockey player and/or the node.

In some embodiments, the information may be displayed along the player in the form of a floating box. This floating box may expand from the model or one of the nodes of the model (and not necessarily the node that it linked to a certain piece of information). For example, the user may interact with the node on the model's feet to display the speed the model is traveling; however, for the sake of viewability and/or clarity, the information may be displayed via a floating box that expands from the node at the top of the model, at its head. Expanding the floating box from the node at the head of the model means that the floating box should not obfuscate or block the model and this clarity may be desirable for some users. The floating boxes typically follow the node they are attached to, said node coordinates that are tracked and updated frame by frame in the present invention, and may either create a visual stack of interacted elements or the floating boxes may overlap one another similar to non-full screen programs present on a computer desktop. Further, the information may be semi-transparent. This allows the user to see other models behind the floating box.

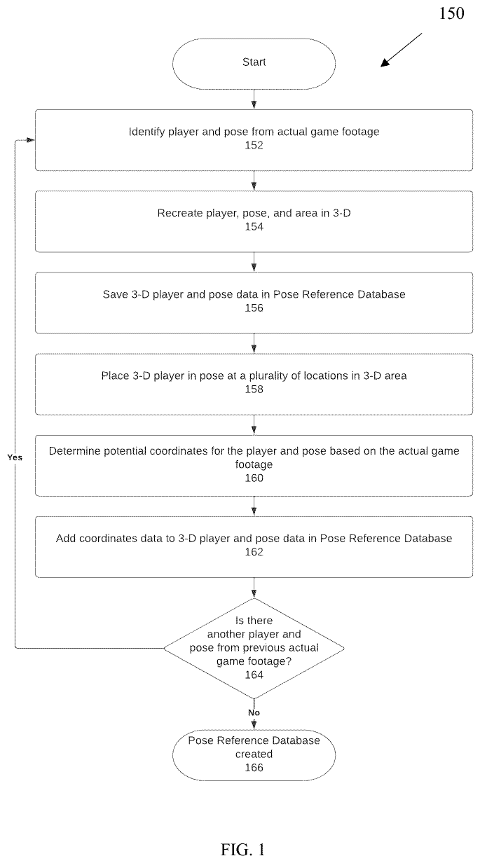

FIG. 1 displays an exemplary embodiment of a workflow for creating a 3-D model and pose reference database 150. In some embodiments, the selected 2-D video media being a sporting event, a player and a pose are identified (or detected) by at least one software component from the actual 2-D game footage 152. The 2-D video media may be viewed either as a single frame or as a sequence of multiple frames by the at least one identification software component. The at least one identification software component includes object identification software, multiple object identification software, 2-D pose identification software, object tracking software, multiple object tracking software, and similar frameworks which accomplish similar goals. This identification may also be performed by the reference controller. Once identified, pose estimation software generates a pose for at least one of the models for the identified objects. This pose estimation software commonly detects and/or identifies not only that the object exists but is able to assign at least one node to the corresponding model to be used by the present invention for various purposes. In some embodiments, multiple nodes are assigned to by the same pose estimation software or a different software component to create joints or keypoints for the model (such as for the shoulder, elbow, wrist, neck, torso, legs, knees, ankles, etc.).

To accurately determine the pose of the at least one model in the area or playing area, the present invention must determine the camera orientation and the portion of the area that is visible within the at least one frame of 2-D video media. Playing surface features such as bounding lines, colored zones or lines, or numerical indicators are all very helpful for the system to identify the video captured portion of the playing area as well as the models/nodes locations on said playing area. Ideally, the system includes at least one program capable of recognizing these playing surface features and a database of relevant play surfaces including templates of playing surfaces, three-dimensional parameters, and rendered areas. Templates of playing surfaces may be recorded at a variety of virtual camera positions and angles. As with the poses for 3-D models, the more pre-rendered virtual camera positions and angles that the system has recorded in a database, likely the quicker and more accurate the processing of 2-D video media into a rendered 3-D recreation. When selecting which template to use for the rendered 3-D recreation, the system may include a corresponding area selection program to calculate the accuracy of the camera position and angle based on highlighted features present in the 2-D video media compared to the rendered 3-D recreation similar to how the system uses the corresponding model selection program. For example, each feature on the playing area may be assigned a positional value to be used for determining accuracy coefficients (and optionally a multiplier for those accuracy coefficients). Then, the corresponding area selection program compiles the aggregate score of all values (accuracy coefficients that may possibly be multiplied so that relevant features are the focal point) and the lowest score would be determined to be the most accurate view, camera position, and camera angle for the rendered 3-D recreation.

Further ideal embodiments of the system includes playing surfaces/areas that not only include the bounds of the playing area but also aesthetic features (such as logos, letters, event information, etc.) that are either generated from the 2-D video media or are retained within a database of playing area features. In alternative embodiments of the present invention not focused on the 3-D recreation of sporting events, the system may identify relevant features of the depicted area and generate simulated areas either from scratch or with the use of at least one reference database (such as recreating the intersection of two streets using recreated signage and building graphics from the 2-D video media).

The system then recreates the player, pose, and area (or playing area/field) in a rendered 3-D recreation of the 2-D video media 154. The player is an example of one of the aforementioned models, having at least one node. The area may also be a model having zero or more nodes.

The 3-D player model and pose data is saved in the pose reference database 156. The system may then prepare model and pose data at a plurality of locations in the rendered area 158. Next, the translation controller may be used to determine potential coordinates for the model and pose of the player based on the actual 2-D game footage 160. Then, coordinates are added to the model and pose data in the pose reference database 162. Finally, the system determines whether there is an additional player and pose data to record 164. If there is an additional player and pose data, the method continues. If there is no additional player and pose data to be recorded, the method ends with the data being created in a pose reference database 166.

Once players, nodes, and/or play areas are identified in at least one frame of 2-D video media, the system may work in one of at least two exemplary ways.

First, as described above, the system may collect aggregate accuracy coefficients/scores for the objects/models, nodes, and/or playing area (including multipliers that may be determined by an algorithm or set by the user) and select the pre-rendered rendered 3-D recreation of 2-D video media within the frames database. One example of a user selected multiplier for the accuracy coefficients is a setting within the user's interface that allows the user to indicate (a “user desired focal point”) that closer nodes of objects (2-D) and models (3-D) near a hockey puck during a hockey game are more important than nodes that are further away (whether this is on a sliding scale or other type of modifier). This allows the system to favor converting the 2-D video media into 3-D while focusing that rendered 3-D recreation on players that are nearest the hockey puck.

Second, the system may compare scores for individual 2-D objects and their 3-D model counterparts and select the 3-D model with the closest accuracy coefficient/score for each object-model pairing. Then, the system may place the selected 3-D model(s) on the rendered 3-D recreation of the play area at each model's closest corresponding location to their corresponding object within the 2-D video media, creating the rendered 3-D recreation in real-time. Those skilled in the art will appreciate that pre-rendered 3-D recreations within a database are almost always going to be quicker to process, retrieve, and send/display to the user than generating rendered 3-D recreations in real-time.

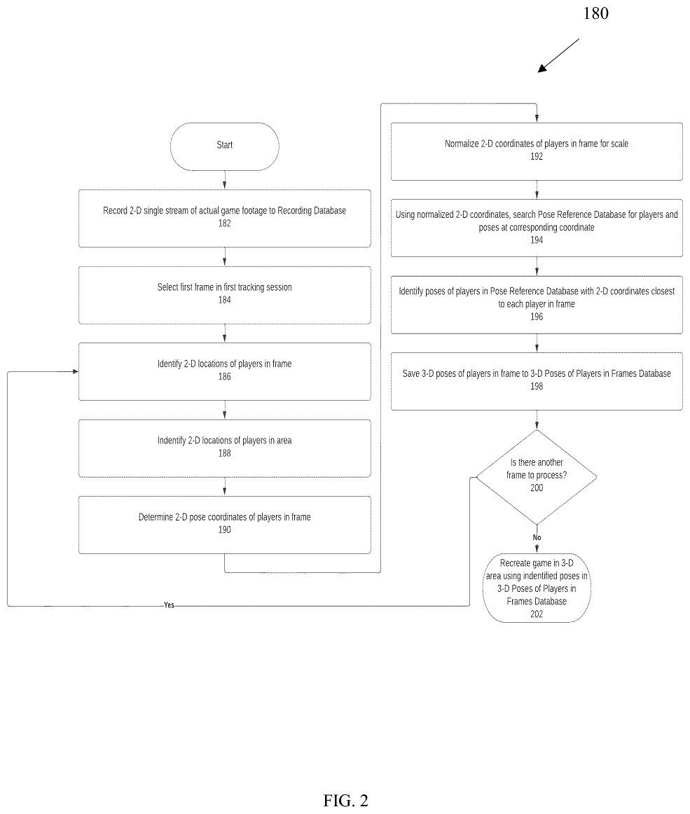

FIG. 2 is a workflow of one embodiment of the method for translation of pose coordinates from a 2-D video media into frames comprising models and poses recreated in a rendered 3-D video media 180. In some embodiments, 2-D game footage (aka video media) is recorded to the recording database 182. The frame controller selects a first frame in a first tracking session 184. The translation controller identifies locations of players in the frame of 2-D game footage 186. This includes first identifying objects in the 2-D video media as players and may be accomplished via software such as multiple object tracking programs.

Then, the translation controller identifies the sporting area and locations of players in that area 188. The translation controller continues to determine the 2-D pose coordinates of players in the area in the frame 190. Next, the translation controller normalizes the 2-D coordinates of the players in the frame for scale 192. Finally, using the normalized 2-D coordinates, the reference controller searches the pose reference database for players and poses at the corresponding coordinates 194. The reference controller identifies players and poses in the pose reference database that are closest to the normalized 2-D coordinates 196. These 3-D poses of players in the area in the frame are saved to the 3-D poses of players in frames database 198. Finally, the system determines whether there is another frame to process 200. If there is another frame to process, the system begins from identifying the location of players in the frame of 2-D game footage 186. If there are no additional frames to process, the system recreates the game in 3-D using the identified poses in the 3-D pose of players in frames database 202.

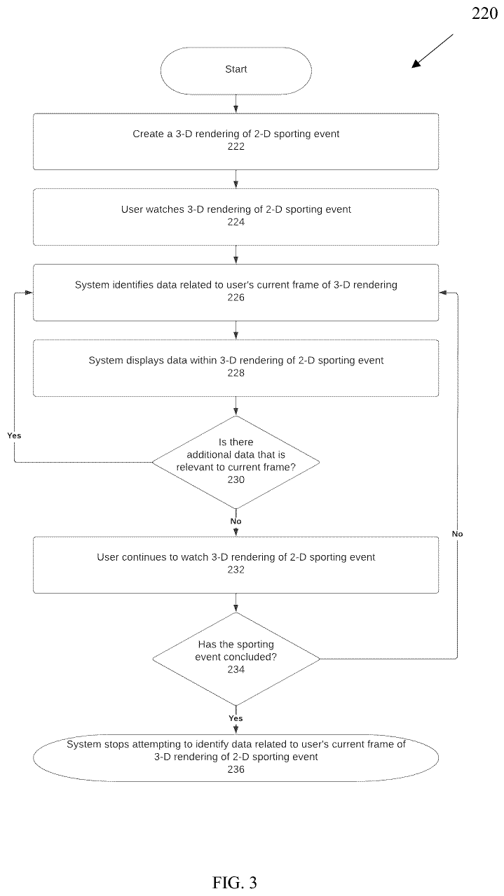

FIG. 3. is a workflow of one embodiment of the method for displaying information on rendered models in a rendered 3-D video media 220. In some embodiments, the method begins with a 3-D rendering of a 2-D sporting event already being created in one of the aforementioned embodiments of the present invention 222. The user watches the 3-D rendering of the 2-D sporting event 224. While a sporting event is chosen to model this embodiment of the present invention due to sports fans being known for appreciating statistics and data about the game and players (and because the example is easy to visualize and understand), it should be understood that other types of video media could be used in alternative embodiments of the present invention. While the user is watching the 3-D rendering, the system identifies models of players and their poses in each frame of the 3-D rendering and correlates those models with data stored in a statistics and information database about the players, their poses, and the sport being played 226. Then, in some embodiments, the system displays the data retrieved from the statistics and information database on the frame of the video stream of the 3-D rendering of the 2-D sporting event 228. Further, there may be additional models in the frame which data could be displayed.

The system may determine whether there is data within the statistics and information database that is relevant to the current frame 230. If there is additional data to display, the system loops and continues to identify models of players and their poses in each frame of the 3-D rendering and correlates those models with data stored in a statistics and information database about the players, their poses, and the sport being played 226. If there is no additional data to display or the system decides to stop displaying additional data (possibly due to a command from a data display controller that determined that there is not enough room in the frame to display additional statistics and information), the system may wait for the next frame to resume the process. The user continues to watch the 3-D rendering of the 2-D sporting event 232. When the 3-D rendering of the 2-D sporting event has concluded 234 the system ceases attempting to identify and correlate data related to the models in the frame 236.

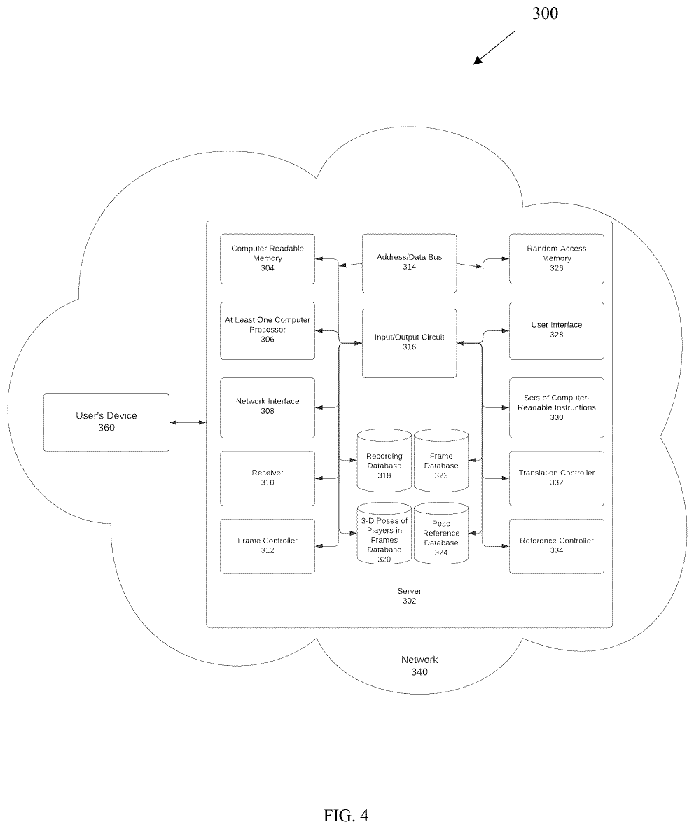

FIG. 4 shows a diagram of an exemplary configuration of the system 300 of one embodiment of the present invention. The system 300 includes a user's device 360, the user's device having an application for viewing the rendered 3-D video media, the application connected to a server 302 via a network 340. Some examples of the user's device 360 include a cellular phone, a tablet, a computer, or any other device that the application may be installed on. The application uses the resources of the user's device, displays information to the user, and facilitates interactions with the user through the graphical user interface and the input/output mechanisms of the user's device. Input/output mechanism includes a touch screen, physical keyboard, voice recognition and typing, and other methods known in the art. The application communicates with the server 302 via a network 340. The server 302 includes computer-readable memory (often referred to as “program memory” or “memory”) 304, at least one computer processor (sometimes referred to as a controller, a microcontroller, or a microprocessor) 306, a random-access memory (“RAM”) 326, an address/data bus 314, a user interface 328, an input/output (“I/O”) circuit 316, a network interface 308, multiple sets of computer-readable instructions 330, a receiver 310, a frame controller 312, a translation controller 332, a reference controller 334, a recording database 318, a 3-D poses of players in frames database 320, a frame database 322, and a pose reference database 324. All of the components of the server 302 are interconnected via the address/data bus 314. The memory 304 may comprise one or more tangible, non-transitory computer-readable storage media or devices, and may be configured to store computer-readable instructions that, when executed by the at least one computer processer 306, cause the server 302 to facilitate operation of the system 300.

Memory 304 may store multiple sets of computer-readable instructions 330 and organize them into modules that can be executed to implement the system 300. Examples of these multiple sets of computer-readable instructions includes the object tracking or multiple object tracking programs, pose estimation programs, corresponding model selection programs, the corresponding area selection programs, and any other program required for the operation, maintenance, use, and implementation of the system of the present invention. Some of these aforementioned computer-readable instructions may be used by or part of the various other components and/or controllers within the system 300.

In one embodiment, the memory 304 stores multiple sets of computer-readable instructions 330 that cause the server 302 to send and receive data to and from the application, generate a one-time password and send it to the user's phone number for a security authentication check, store the user's information, encrypt the user's information, send the encrypted user's information, and mine text stored on the memory 304. The memory 304 may store fewer or additional sets of computer-readable instructions on the server 302 in accordance with the necessities of the system 300. Computer-readable instructions include executable features that cause the computer to generate, receive, send, verify, compute, or otherwise perform some computation to aid in furthering the purpose of the present invention. In some embodiments, the computer-readable instructions 330 may be stored as processes, scripts, applications, and/or modules. In some embodiments, the computer-readable instructions 330 may be stored as routines, subroutines, or other blocks of instructions.

The server 302 may be operatively connected to send and receive communications, data, requests, and/or responses over the network 340 via the I/O circuit 316 and network interface 308. The server 302 may connect to the network 340 at the network interface 308 via a wired or wireless connection, or other suitable communications technology. The network 340 may be one or more private or public networks. The network 340 may be a proprietary network, a secure public internet, a virtual private network, a cellular/mobile network, a broadcast television network, or some other type of network, such as dedicated access lines, plain ordinary telephone lines, satellite links, combinations thereof, etc. Where the network 340 comprises the Internet, data communications may take place over the network 340 via an internet communication protocol. Data is exchanged between the user's device 360, the application, and the server 302 via the network 340.

The server 302 may receive the user's information from applications on one or more of the user's devices 360 via the network 340. The server 302 may also request data or information from applications on one or more of the user's devices 360 via the network 340.

In some embodiments, the memory 304 may include a database or databases that may be configured to store data related to the system 300. The database(s) may be used to store various data and information, including information about the user (including PII), information received from the user, web traffic metrics, geographic data from the user's device 360, and/or any other data or information that is measurable and/or recordable through the use of the system 300. Alternatively, the database may not be located within the memory 304 of the server 302 and may be located remotely or within a cloud storage service.

In some embodiments, a receiver 310 receives video media from a source within the network 340 via the network interface 308. In alternate embodiments, the receiver 310 may receive the 2-D video media via a non-network means such as a flash drive or DVD. The received video media may be paused and/or a frame of video footage selected by a frame controller 312. The selected frames are saved to a recording database 318, which has a collection of desired frames of video media. A translation controller 332 may include software adept in object detection, object identification, object tracking, object re-identification, mapping, location, and other algorithms, services, and/or programs to facilitate the identification, selection, tracking, and capture of desired object from 2-D video media into 3-D models. The translation controller 332 may also include software that identifies at least one pose of the objects within the 2-D video media and creates 3-D renderings of them as models in at least one pose. Selected models and their poses are recorded to a pose reference database 324.

With models and poses pre-generated, a reference controller 334 may identify the models in the same or a new stream of video media. Then, along with the object detection, object re-identification, and other algorithms, the reference controller may select each model at an appropriate location to recreate the 2-D video media into the rendered 3-D video media. These frames of video media may be stored in a 3-D poses of players in frames database 320.

In some embodiments, the system 300 may include additional modules, components, and databases to facilitate the operation of the present invention and its features. One example of an additional module is an interactable element controller which generates and places the interactable element that, in some embodiments, appears in frames of the rendered 3-D video media. The interactable element controller may correlate statistics and information stored about the players represented by the model in the frames of the rendered 3-D video media. These statistics and information may be stored in the statistics and information database. As way of example, the interactable element controller may detect a certain player in a frame of the rendered 3-D video media, pull scoring statistics related to that certain player from the statistics and information database, and place an interactable element on the certain player's hand that, when manipulated by the user, displays the pulled scoring statistics in a pop-up display box. The interactable element may also be useful by taking the user to another point during the game, show optional paths and plays that the players could have made, or display other statistical, social, or interesting information. In some embodiments, the interactable element controller may include an algorithm or program designed to select which information is most relevant “in the moment” or has the most “interesting” value to the user.

Although the components of the server 302 are shown in single blocks in the diagram, it should be understood that the memory 304, RAM 326, I/O circuit 326, and other components may be made up of multiple, a set, or a series of those components. For example, there may be several RAM 326 components (sometimes called “RAM sticks”) installed within the server 302.

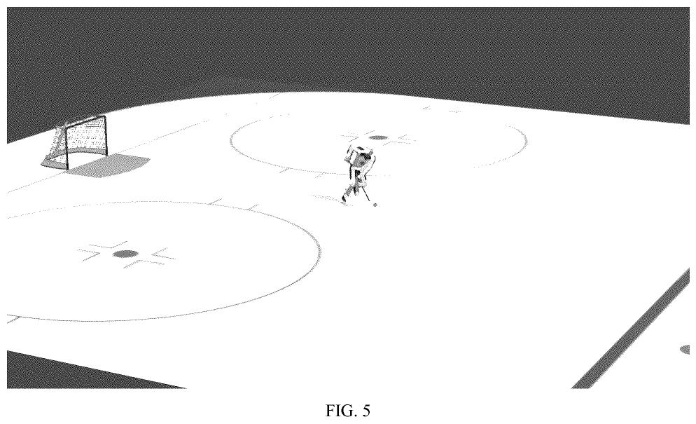

FIG. 5 depicts a rendered 3-D model of a single hockey player with a generated nodal skeleton (or “rig”). As previously mentioned, the depicted player has been detected, identified, (and when considering more than a single frame of 2-D video media, re-identified), and assigned a skeleton having at least two nodes with telescoping and rotary points between those modes so that the assigned rendered 3-D model may accurately represent the player in the 2-D frame(s). These nodes may be assigned, in some embodiments, to the player in the 2-D video media by the pose estimate program. Then, the corresponding rendered 3-D model is selected and placed at the closest location within the play area by the corresponding model selection. Alternatively, the system may select the pre-rendered frame of 3-D video media most closely resembling the 2-D video media.

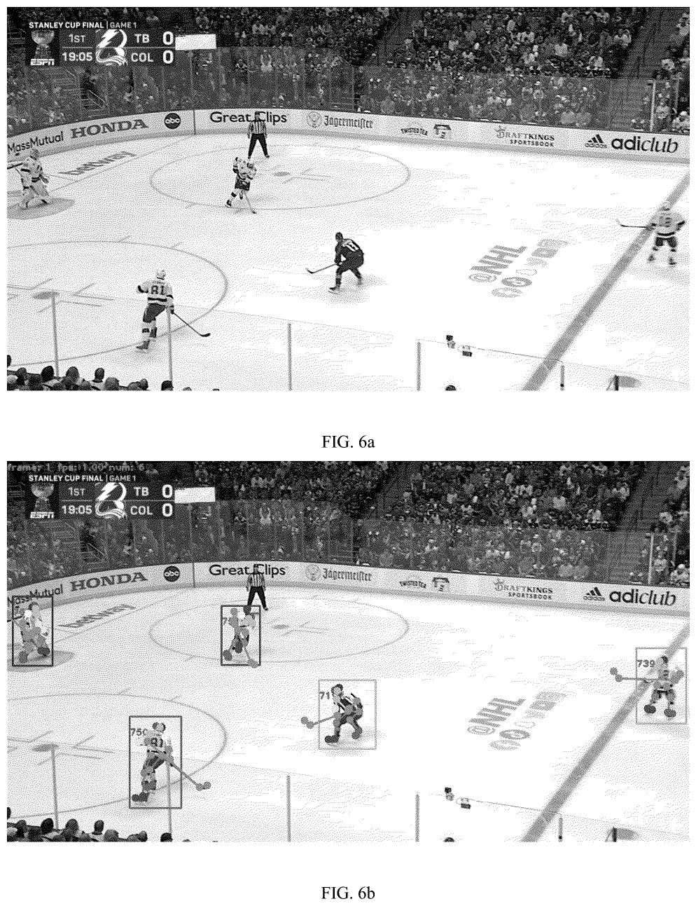

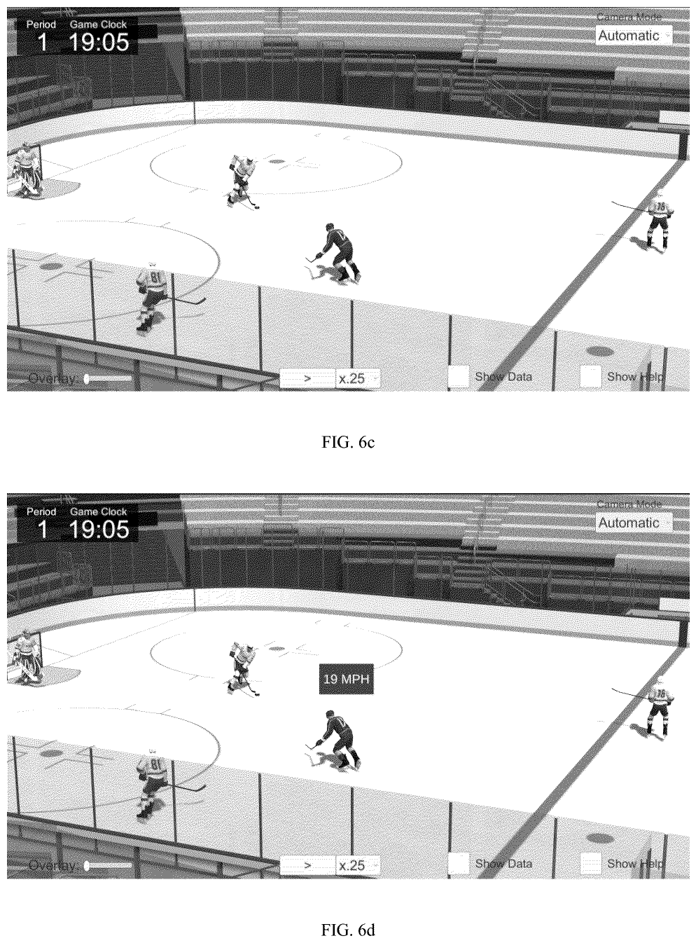

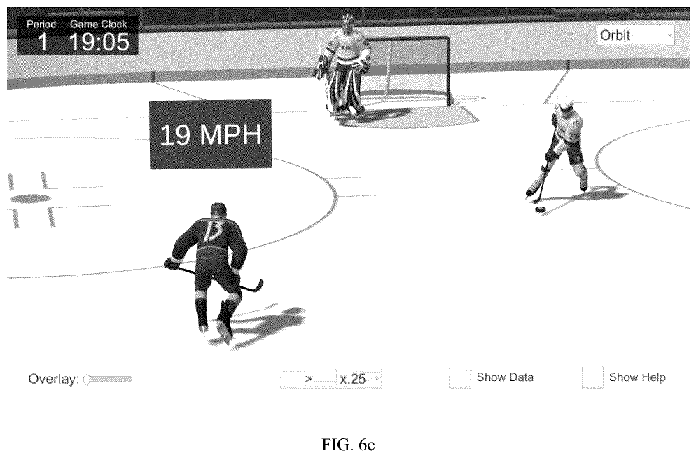

FIGS. 6a-6e are of various stages of processing of one embodiment of the present invention. FIG. 6a depicts a frame of 2-D video media from a sporting event (hockey in this instance). The frame prominently displays several players in the playing area, one referee, and a crowd outside the playing area. FIG. 6b provides an intermediate step of the present invention wherein the desirable 2-D objects (the players) have been identified, tracked, and assigned bounding boxes and nodal skeletons (or “rigs”). These bounding boxes and nodal skeletons are vital to allow the present invention to either place models of players at corresponding spots in the rendered 3-D recreation or to select the pre-rendered frame of 3-D video media that most closely resembles the frame of 2-D video media. Notably, the MOT program is instructed and/or trained to not track certain objects such as the referee or people in the crowd. This reduces the needed processing power and visual clutter on the output rendered 3-D recreation.

FIG. 6c depicts a rendered 3-D recreation of the corresponding 2-D video media of FIGS. 6a and 6b. Again, the referee and crowd are not generated to reduce processing time; however, some embodiments may include models for those objects from the 2-D video media. Looking closely at FIGS. 6b and 6c it can be noted that the players in both the 2-D and 3-D video medias are in almost exactly the same locations and in very similar, if not identical (in some cases) poses. Further, FIG. 6d is of the same frame of rendered 3-D recreation as 6c and features a chat box displaying the speed of the player (“19 MPH”) over the player after the user interacted with the relevant interactable element on that player.

FIG. 6e is the same frame of rendered 3-D recreation as FIG. 6d; however, the camera angle has been changed by the user. Further, without closing the chat box from the interactable element, the speed of the linked player is still displayed and has recentered in the frame on the player on the relevant player.

It should be understood that any of the examples described herein may include various other features in addition to or in lieu of those described above. By way of example only, any of the examples described herein may also include one or more of the various features disclosed in any of the various references that are incorporated by reference herein. For example, while the preceding disclosure generally explains the translation of real-world objects from 2-D video media to rendered 3-D models in a more interactive piece of video media (possibly also 3-D and interactable), the source 2-D video media could also be composed of rendered models.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be understood that rendered three-dimensional video media and rendered 3-D video media refer to the same thing. Likewise, two-dimensional video media and 2-D video media refer to the same thing. This and other shortenings of terms are merely done for convenience and clarity and in no way provide a limitation to any element of any claim contained within this disclosure.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods, systems, and apparatus described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented method for converting two-dimensional video media into a rendered three-dimensional video media, comprising the steps of:
identifying at least one object from at least one frame of two-dimensional video media;
assigning at least one node to the at least one object;
determining location data for the at least one object based on the at least one frame;
determining pose data for the at least one object within the at least one frame;
rendering at least one rendered model to be placed and posed in a rendered area of a rendered three-dimensional recreation of the two-dimensional video media, wherein the rendered model is used to replace its counterpart at least one object from the two-dimensional video media, and the rendered model having at least one node that correlates to the at least one node of the at least one object;
generating a plurality of poses for the at least one rendered model in a plurality of locations in the rendered area and said plurality of poses being generated by manipulating the rendered model's at least one node;
storing the location and pose data of the at least one node of the at least one rendered model within at least one pre-rendered frame of the rendered area in at least one database;
comparing the location and pose data of the at least one node of the at least one object with the corresponding at least one node of the at least one rendered model within the database;
selecting the pre-rendered frame within the database containing the at least one rendered model at a corresponding location and pose that most closely aligns with the at least one node of the at least one object from the two-dimensional video media; and
displaying to a user the pre-rendered frame most closely corresponding to the two-dimensional video stream.

2. The computer-implemented method for converting a two-dimensional video media into a rendered three-dimensional video media of claim 1, further comprising the steps of:
generating at least one interactable element that corresponds to a at least one node of the at least one rendered model;
receiving manipulation by a user at the at least one interactable element; and
displaying information related to the at least one rendered model.

3. The computer-implemented method for converting a two-dimensional video media into a rendered three-dimensional video media of claim 1 wherein the two-dimensional video media is a live broadcast.

4. The computer-implemented method for converting a two-dimensional video media into a rendered three-dimensional video media of claim 3 wherein the rendered three-dimensional video media is displayed in relatively real-time in relation to the live broadcast of the two-dimensional video media.

5. The computer-implemented method for converting a two-dimensional video media into a rendered three-dimensional video media of claim 1 wherein the plurality of poses for each rendered model is created by an individual and stored in a pose reference database.

6. The computer-implemented method for converting a two-dimensional video media into a rendered three-dimensional video media of claim 1 wherein the plurality of poses for each rendered model is generated by an application and stored in a pose reference database.

7. The computer-implemented method for converting a two-dimensional video media into a rendered three-dimensional video media of claim 1 further comprising a pre-rendered frames database which stores frames of pre-rendered three-dimensional video media including at least one rendered model in at least one pose from a pose reference database at at least one location within the rendered area.

8. The computer-implemented method for converting a two-dimensional video media into a rendered three-dimensional video media of claim 7 wherein a model selection program selects the pre-rendered frame from the pre-rendered frames database based on a calculated accuracy coefficient of at least one node of at least one object and its corresponding at least one node of at least one rendered model at locations of the rendered area within the pre-rendered frame.

9. The computer-implemented method for converting a two-dimensional video media into a rendered three-dimensional video media of claim 8 wherein the model selection program considers a multiplier on at least one of the accuracy coefficients to favor selecting the pre-rendered frame of three-dimensional video media within the pre-rendered frames database that displays the most user desired focal point of the corresponding frame of the two-dimensional video media.

10. The computer-implemented method for converting a two-dimensional video media into a rendered three-dimensional video media of claim 1 wherein the user may adjust the viewing angle of the rendered three-dimensional video media during playback.

11. The computer-implemented method for converting a two-dimensional video media into a rendered three-dimensional video media of claim 1 wherein the two-dimensional video media's live broadcast is received at a server containing the pre-rendered frames database, the server containing and using the model selection program to select frames of pre-rendered three-dimensional video media that are most like the two-dimensional video media based on the accuracy coefficient, and said server broadcasting the pre-rendered three-dimensional video media to a user's device.

12. The computer-implemented method for converting a two-dimensional video media into a rendered three-dimensional video media of claim 1 wherein the at least one rendered model is pre-rendered prior to the conversion of two-dimensional video media into a rendered three-dimensional recreation.

13. A computer system for converting a two-dimensional video media into a rendered three-dimensional video media comprising:
at least one computer processor;
at least one frame controller;
at least one translation controller;
at least one reference controller; and
a program memory storing executable instructions that when executed by at least one computer processor causes the computer system to:
render at least one rendered model to be used in a rendered area of at least one frame of a rendered three-dimensional video media, said at least one rendered model being used to replace a counterpart at least one object of the rendered model from a two-dimensional video media, and said rendered model having at least one node;
store a plurality of poses for the at least one rendered model in a plurality of locations in the rendered area in a pose reference database;
store at least one pre-rendered frame of the at least one rendered model within the rendered area at pluralities of locations and poses in a pre-rendered frames database;
assign location and pose data for the at least one node of the at least one rendered model within the at least one pre-rendered frame within the pre-rendered frames database;
capture and assign location and pose data from at least one frame of two-dimensional video media for at least one object that is the counterpart of the at least one rendered model;
select the pre-rendered frame from the pre-rendered frames database having the most desirable accuracy coefficient between the at least one object of the two-dimensional video media and the at least one rendered model of the pre-rendered frame;
generate at least one interactable element that corresponds to at least one node of the at least one rendered model;
display the pre-rendered frame to a user;
receive manipulation by the user at the interactable element; and
display information via the interactable element that is related to the manipulated node of the rendered model.

14. The computer system for converting a two-dimensional video media into a rendered three-dimensional video media of claim 13 wherein the two-dimensional video media is a live broadcast.

15. The computer system for converting a two-dimensional video media into a rendered three-dimensional video media of claim 14 wherein the three-dimensional video media is displayed in relatively real-time in relation to the live broadcast of the two-dimensional video media.

16. The computer system for converting a two-dimensional video media into a rendered three-dimensional video media of claim 13 wherein the plurality of poses for each rendered model is created by an individual.

17. The computer system for converting a two-dimensional video media into a rendered three-dimensional video media of claim 13 wherein the plurality of poses for each rendered model is generated by an application.

18. The computer system for converting a two-dimensional video media into a rendered three-dimensional video media of claim 13 wherein the posed rendered models are stored in a pose reference database.

19. The computer system for converting a two-dimensional video media into a rendered three-dimensional video media of claim 13 further comprising a model selection program instructed to apply a multiplier to at least one accuracy coefficient when evaluating which pre-rendered frame to display to the user.
